(19) United States
(12) Patent Application Publication
(10) Pub. No.: US 2021/0087973 A1
(43) Pub. Date: Mar. 25, 2021

(54) SYSTEM AND METHOD FOR STARTING A GAS TURBINE ENGINE

(71) Applicant: PRATT & WHITNEY CANADA CORP., Longueuil (CA)

(72) Inventors: Issam AL-KHAIRY, Verdun (CA); Tarek MANSOUR, Montreal (CA)

(21) Appl. No.: 16/582,851

(22) Filed: Sep. 25, 2019

(51) Int. Cl. F02C 7/266

(52) U.S. Cl. CPC F02C 7/266; F05D 2220/32

(57) ABSTRACT

Systems and methods for starting an engine are described herein. An electronic engine controller is configured to output a first voltage signal comprising at least one pulse when commanded to start the engine. The first voltage signal has a maximum amplitude below an igniter voltage threshold. A voltage transformer is coupled to the electronic engine controller and configured to transform the first voltage signal received from the electronic engine controller into a second voltage signal having a maximum amplitude equal to or above the igniter voltage threshold. At least one igniter is coupled to the voltage transformer and configured to ignite a fuel-air mixture in a combustor of the engine with the second voltage signal received from the voltage transformer.

### TECHNICAL FIELD

The present disclosure relates generally to engine starting, and, more particularly, to systems and methods for starting a gas turbine engine.

### BACKGROUND OF THE ART

A gas turbine engine may have an ignition system that generates a spark to ignite a fuel-air mixture to start the engine. More specifically, an exciter may be used to provide a high voltage pulse signal to an igniter in a combustor of the engine, which causes a spark to be produced across a gap of the igniter. High voltage leads from the exciter to the igniter may be used to transmit the high voltage pulse signal. However, high voltage transmission may result in an electrical arc that could cause damage to the engine and/or other components connected to the engine.

As such, there is room for improvement.

### SUMMARY

In one aspect, there is provided a system for starting an engine. The system comprises: an electronic engine controller configured to output a first voltage signal comprising at least one pulse when commanded to start the engine, the first voltage signal having a maximum amplitude below an igniter voltage threshold; a voltage transformer coupled to the electronic engine controller and configured to transform the first voltage signal received from the electronic engine controller into a second voltage signal having a maximum amplitude equal to or above the igniter voltage threshold; and at least one igniter coupled to the voltage transformer and configured to ignite a fuel-air mixture in a combustor of the engine with the second voltage signal received from the voltage transformer.

In another aspect, there is provided a method for starting an engine The method comprises: generating, at an electronic engine controller, a first voltage signal comprising at least one pulse, the first voltage signal having a maximum amplitude below an igniter voltage threshold; transforming, at a voltage transformer, the first voltage signal into a second voltage signal, the second voltage signal having a maximum amplitude equal to or above the igniter voltage threshold; and igniting, by at least one igniter, a fuel-air mixture in a combustor of the engine with the second voltage signal.

### DESCRIPTION OF THE DRAWINGS

Reference is now made to the accompanying figures in which:

FIG. 1 is a schematic cross-sectional view of an example gas turbine engine, in accordance with one or more embodiments;

FIG. 2 is a schematic of an example system for starting an engine, in accordance with one or more embodiments;

FIG. 3 is a signal diagram illustrating a first voltage signal generated by an electronic engine controller and second voltage signal produced from the first voltage signal by a voltage transformer, in accordance with one or more embodiments;

FIG. 4 is a schematic of another example system for starting an engine, in accordance with one or more embodiments;

FIG. 5 is a flowchart illustrating an example method for starting an engine, in accordance with one or more embodiments;

FIG. 6 is an example computing device, in accordance with one or more embodiments.

It will be noted that throughout the appended drawings, like features are identified by like reference numerals.

### DETAILED DESCRIPTION

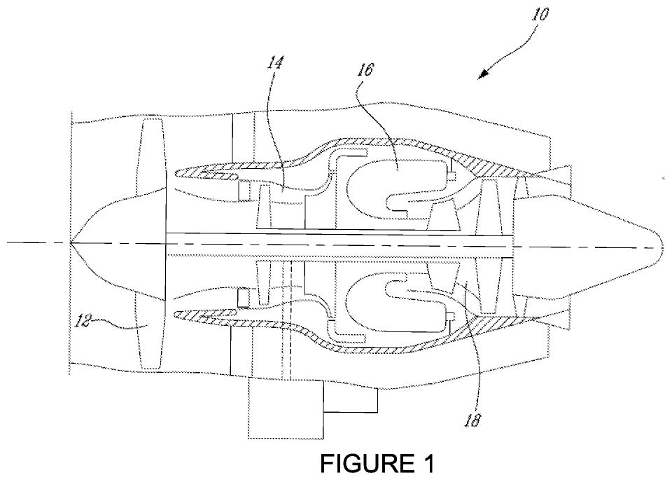

FIG. 1 illustrates a gas turbine engine 10 that may be started using the systems and methods described herein. Note that while engine 10 is a turbofan engine, the systems and methods for starting an engine may be applicable to turboprop engines, turboshaft engines, other types of aircraft engines and any other suitable types of engines (e.g., industrial engines, automotive engines, auxiliary power units, etc.). The engine 10 generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

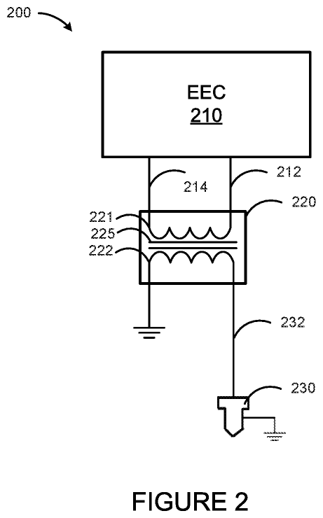

With reference to FIG. 2, a system 200 for starting an engine, such as the engine 10, is illustrated. While FIG. 2 is described herein with reference to the engine 10, this is for example purposes only and the system 200 may be used to start any suitable engine. An electronic engine controller (EEC) 210 is configured to output a first voltage signal comprising at least one pulse when commanded to start the engine. The first voltage signal is a low voltage signal. A voltage transformer 220 is coupled to the EEC 210 and configured to transform the first voltage signal received from the EEC 210 into a second voltage signal. The second voltage signal is a high voltage signal. Accordingly, the voltage transformer 220 amplifies the first voltage signal to produce the second voltage signal. The second voltage signal comprises at least one pulse. At least one igniter 230 is coupled to the voltage transformer 220 and configured to ignite a fuel-air mixture in the combustor 16 of the engine 10 with the second voltage signal received from the voltage transformer 220.

It should be appreciated that by providing a low voltage pulse signal from the EEC 210 to the voltage transformer 220, without the use of an exciter, that the reliability of the starter systems may be improved. This is because the low voltage pulse signal from the EEC 210 may be less likely to cause an electrical arc than the transmission of a high voltage signal by an exciter. Moreover, this configuration may also simplify the design of starter systems (e.g., by reducing installation requirements, dielectric margin requirements, hermetic sealing, and the like). Weight and/or cost savings may also be obtained by implementing the systems and/or methods described herein.

The EEC 210 is powered by one or more power sources. The power source may be a power bus, a battery or any other suitable power source. For example, one or more electrical buses of an aircraft may provide power to the EEC 210. The EEC 210 is configured to receive a command to start the engine 10. The command may be received from a control mechanism or an aircraft or engine computer. For example, the command may be received from a power lever or other control mechanism or computer in a cockpit of an aircraft. The EEC 210 provides the first voltage signal to the voltage transformer 220 by use of wiring 212, 214. In other words, the wiring 212, 214 couples the EEC 210 to the voltage transformer 220. The wiring 212, 214 is low voltage electrical wiring for transmission of the low voltage signals. For example, the wiring 212, 214 may be rated for low voltage transmission. The wiring 212, 214 may be provided as part of a harness of the engine 10 in order to electrically connect the EEC 210 to the voltage transformer 220.

The voltage transformer 220 may be any suitable passive electronic device that transforms the first voltage signal into the second voltage signal. In the illustrated embodiment, the voltage transformer 220 comprises a primary coil 221, a secondary coil 222 and a core 225. The primary coil 221 and the secondary coil 222 may be copper wiring or any other suitable wiring. The core 225 may be any suitable magnetic core (e.g., a laminated iron core, a solid iron core, or any other coil made of ferromagnetic material(s)). The primary coil 221 is wrapped around the core 225 a given number of turns N and the secondary coil 222 is wrapped around the core 225 a given number of turns M. The number of turns N and M may vary depending on practical implementations. In general, the number of turns N and M are set such that the voltage transformer 220 is able to amplify the first voltage signal into the second voltage signal having a maximum amplitude that is equal to or exceeds an igniter voltage threshold. The first voltage signal has a maximum amplitude that is below the igniter voltage threshold. The igniter voltage threshold is the threshold required by the igniter 230 to start the engine 10. In other words, the igniter voltage threshold corresponds to a value that if meet or exceeded causes the igniter 230 to generate a spark. The igniter voltage threshold may vary depending on practical implementations, as the igniter voltage threshold varies depending of the igniter used. In some embodiments, the voltage transformer 220 is an ignition coil, which is a specific type of voltage transformer used for engine ignition. The ignition coil may be configured to have an open magnetic circuit (i.e., the core 225 does not form a closed loop around the windings of the primary and secondary coils 221, 222).

In the illustrated embodiment, the wire 212 provides the first voltage signal from an output port of the EEC 210 to the primary coil 211. More specifically, a first end of the wire 212 is connected to the output port of the EEC 210 and a second end of the wire 212 is connected to a first end of the primary coil 221. The wire 214 grounds a second end of the primary coil 221 to the ground of the EEC 210. That is, a first end of the wire 212 is connected to the second end of the primary coil 211 and a second end of the wire 212 is connected to ground of the EEC 210. The wiring 212, 214 may vary depending on practical implementations.

In the illustrated embodiment, an ignition lead 232 is used to couple the voltage transformer 220 to the igniter 230. More specifically, a first end of the ignition lead 232 is connected to a first end of the secondary coil 222 and a second end of the ignition lead 232 is connected to the igniter 230 (e.g., to an electrode of the igniter 230). The ignition lead 232 is a high voltage electrical wire for transmission of the high voltage signals. The ignition lead 232 may vary depending on practical implementations. The second end of the secondary coil 222 is connect to ground. The ground connection of the secondary coil 222 may be electrically isolated from the ground of the EEC 210. For example, the secondary coil 222 may be grounded to the ground of the engine 10. In embodiments having more than one igniter, each igniter may have a separate ignition lead to the voltage transformer 220. In alternative embodiments, the igniter 230 is integrated with the voltage transformer 220. In other words, the igniter 230 may be coupled to the voltage transformer 220 without the use of ignition leads 232.

The igniter 230 is positioned in the combustor 16 of the engine 10. The igniter 230 is a device that is configured to deliver electric current from the second voltage signal to ignite a compressed fuel-air mixture in the combustor 16 by an electric spark. Any suitable igniter may be used. For instance, the igniter 230 may have a metal shell connected to ground and electrically isolated from a central electrode by an insulator. The electrode may protrude from the insulator into the combustion chamber 14 of the engine 10 for forming a spark gap when the second voltage signal is received. The igniter 230 may be referred to as a “spark plug”. The ground connection of the igniter 230 may be the same ground that the secondary coil 222 is connected thereto.

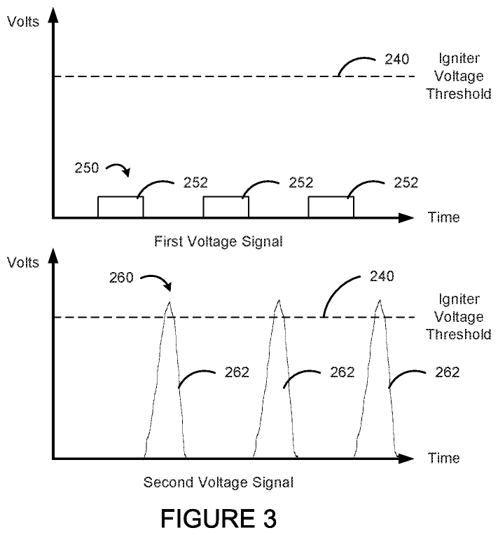

With reference to FIG. 3, a signal diagram illustrates an example of the first voltage signal 250 and the second voltage signal 260. The shape of the first voltage signal 250 and the second voltage signal 260 is for illustrative purposes only and would vary depending on practical implementations. In this example, the first voltage signal 250 comprises a plurality of pulses 252. The first voltage signal 250 may be a square wave or have any other suitable shape. The first voltage signal 250 has a maximum amplitude below the igniter voltage threshold 240. That is, each of the pulses 252 has a maximum amplitude below the igniter voltage threshold 240. The amplitude, the timing and the shape of the pulses 252 may be controlled by the EEC 210 for starting the engine 10. For example, a module of the EEC 210 (e.g., incorporated within the printed circuit board of the EEC 210) may be used to set the amplitude, the timing and the shape of the pulses 252. The amplitude, the timing and the shape of the pulses 252 may be set depending on various factors, for example, such as the voltage supplied to the EEC 210, the configuration of the voltage transformer 220 and the configuration of the igniter 230. For example, the amplitude, the timing and/or the shape of the pulses 252 may vary depending one or more of the following factors: the capabilities of the low voltage power supply of the EEC 210, the circuit design of the EEC 210, electromagnetic interference considerations for the EEC 210 and the transformer 220, arcing considerations within the EEC 210, spark characteristics and delivered energy requirements, transformer design and efficiency. There may be other design considerations that could be raised during a detailed design of the system to optimize complexity, weight, cost, reliability that may affect the amplitude, the timing and/or the shape of the pulses 252. The first voltage signal 250 is a low voltage signal, which may be defined by a low voltage threshold. The low voltage threshold corresponds to the maximum amplitude of the low voltage signal. In other words, the low voltage signal has a maximum amplitude equal to or below the low voltage threshold. The low voltage threshold would vary depending on practical implementations. The low voltage threshold may be 1,500 volts (V), 1,000 V, 500 V, 100 V, 50 V, 30 V, 28 V, 24 V, 20 V, 12 V or any other suitable value. The low voltage threshold may vary from the igniter voltage threshold 240.

The first voltage signal 250 is output by the EEC 210 for starting the engine 10, but has a voltage level insufficient for starting the engine 10 by the igniter 230 (i.e., the maximum amplitude of the first voltage signal 250 is below the igniter voltage threshold 240). Accordingly, the voltage transformer 220 amplifies the first voltage signal 250 to produce the second voltage signal 260. In the example of FIG. 3, the second voltage signal 260 comprises a plurality of pulses 262. The second voltage signal is provided to deliver energy to the igniter(s) 230 and may vary depending on the igniter(s). Accordingly, the second voltage signal may vary depending on practical implementations. The second voltage signal 260 has a maximum amplitude equal to or above the igniter voltage threshold 240. That is, one or more of the pulses 262 has a maximum amplitude equal to or above the igniter voltage threshold 240. The second voltage signal 260 is a high voltage signal, which may be defined by a high voltage threshold. The high voltage threshold corresponds to a value that the maximum amplitude of the high voltage signal equals or exceeds. The high voltage threshold may vary depending on practical implementations. The high voltage threshold may be 500 V, 1,000 V, 5,000 V, 12,000 V, 25,000 V, 45,000 V or any other suitable value. The high voltage threshold may vary from or correspond to the igniter voltage threshold 240.

Referring back to FIG. 2, in some embodiments, the EEC 210 is configured for monitoring the first voltage signal to assess an electromagnetic field produced by the voltage transformer 210 on the first voltage signal. When the spark occurs at the igniter 230, current is produced at the secondary coil 222 which results in the voltage supplied to the primary coil 211 being affected. Accordingly, by monitoring the first voltage signal, at least one spark characteristics of at least one spark produced by the igniter 230 may be determined. The determined spark characteristic(s) may be used for diagnosis purposes. The EEC 210 may monitor the first voltage signal to characterize the current or voltage of the first voltage signal at the time when a spark is expected occur or fail to occur. By characterizing the first voltage signal, it can be determined therefrom if a spark occurred or failed to occur. Accordingly, the EEC 210 may be able to detect that a spark occurred or failed to occur from the monitored first voltage signal. The EEC 210 may be able to detect that the engine 10 has failed to start specifically due to a lack of sparking from the monitored first voltage signal. By determining if sparking occurred or not, this may help in troubleshooting. For example, if a spark did occur, but the engine 10 failed to start, this may indicate that the ignition system is not at fault. However, if the engine fails to start, and the EEC 210 determines that there was no spark, there may a problem with the ignition system. Different fault modes of the ignition system may affect the first voltage signal differently and by characterizing the first voltage signal and comparing the characterization to one or more reference characteristics corresponding to different types of faults, the type of fault that occurred (e.g., a fault at the transformer 220, a fault at the igniter 230, a fault at the ignition lead 232, a fault at the low voltage wiring 212, etc.) may be determined. The EEC 210 may be able to record each spark's characteristics to monitor trends in the starting of the engine 10 over time. The first voltage signal may be monitored by obtaining measurements of the first voltage signal by a computing device of the EEC 210 that generates the first voltage signal (e.g., a microprocessor or microcontroller, a digital signal processor (DSP), a central processing unit (CPU), an integrated circuit, a field programmable gate array (FPGA), or the like). The first voltage signal may be monitored by obtaining measurements of the first voltage signal with one or more sensors connected to the EEC 210 and which are configured to monitor the first voltage signal. The EEC 210 may be implemented such that it is able to monitor the first voltage signal to determine the electromagnetic field. In some embodiments, the electromagnetic field may be monitored by obtaining measurements of the electromagnetic field on the first voltage signal with one or more sensors or by use of another coil assembly or other suitable part(s). It should be appreciated that by monitoring the first voltage signal and/or the electromagnetic field that improved diagnostics may be obtained.

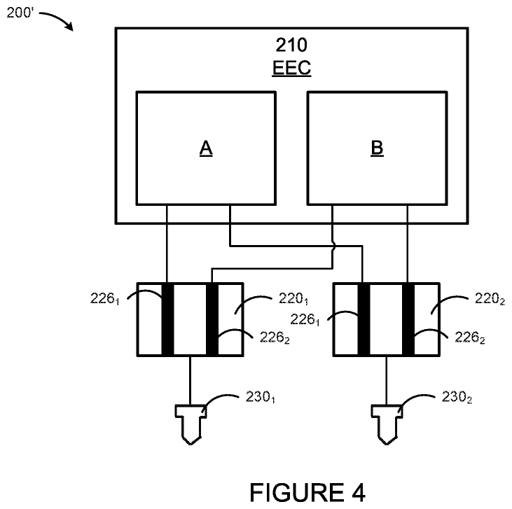

In some embodiments, the EEC 210 may have two channels. With reference to FIG. 4, there is shown a system 200′ for starting an engine, such as the engine 10. The system 200′ is a variant of the system 200, and illustrates an example where the EEC 210 has two channels A, B. Each channel A, B, is configured to be able to output the first voltage signal. In this example, two voltage transformers 220₁, 220₂ are coupled to the EEC 210 and each transformer 220₁, 220₂ is configured to be able to transform the first voltage signal when received from the EEC 210 into the second voltage signal. Wring similar to the wiring 212, 214 of FIG. 2 may be used to connect the EEC 210 to the voltage transformers 220₁, 220₂. In this example, each transformers 220₁, 220₂ is a dual-coil transformer comprising a first coil set 226₁ and a second coil set 226₂. Each coil set 226₁, 226₂ comprises a primary coil, a secondary coil, and a core in a similar manner to the primary coil 221, a secondary coil 222 and a core 225 of transformer 220 of FIG. 2. In this example, the first channel A is connected to the first coil set 226₁ of each transformer 220₁, 220₂ and the second channel B is connected to the second coil set 226₂ of each transformer 220₁, 220₂. An active channel of the EEC 210 (e.g., the first channel A) may output the first voltage signal and the corresponding coil set (e.g., the first coil sets 226₁) of each transformer 220₁, 220₂ may each transform the first voltage signal into the second voltage signal. At least one first igniter 230₁ is coupled to the first voltage transformer 220₁ and is configured to ignite the fuel-air mixture in the combustor 16 of the engine 10 with the second voltage signal when received from the first voltage transformer 220₁. Similarly, at least one second igniter 230₁ is coupled to the second voltage transformer 220₂ and is configured to ignite the fuel-air mixture in the combustor 16 of the engine 10 with the second voltage signal when received from the second voltage transformer 220₂. Ignition leads similar to the ignition lead 232 may be used to connect the first igniter 230₁ to the first voltage transformer 220₁ and to connect the second igniter 230₂ to the second voltage transformer 220₂. Alternatively, the first igniter 230₁ may be integrated with the first voltage transformer 220₃ and/or the second igniter 230₂ may be integrated with the second voltage transformer 220₂ and the corresponding ignition lead(s) may be omitted. It should be appreciated that if one of the transforms 220₁, 220₂, igniters 230₁ 230₂, or channels A, B fails that the engine 10 may still be started with the configuration in FIG. 4.

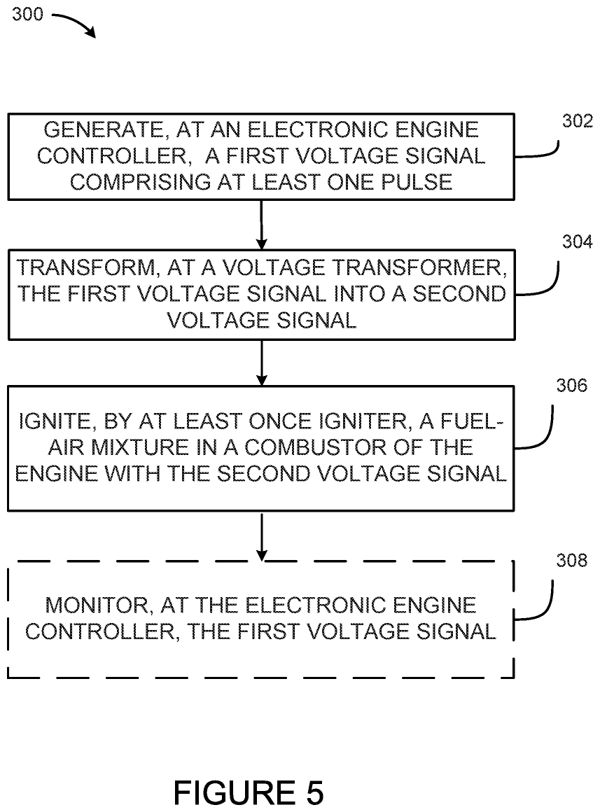

With reference to FIG. 5, there is shown a flowchart illustrating an example method 300 for starting an engine, such as the engine 10. While the method 300 is described herein with reference to the engine 10 of FIG. 1, this is for example purposes only. The method 300 may be applied to any suitable engine. At step 302, a first voltage signal 250 comprising at least one pulse 252 is generated at an EEC 210. The first voltage signal has a maximum amplitude below an igniter voltage threshold 240. The EEC 210 generates and outputs the first voltage signal 250 when commanded to start the engine 10. At step 304, the first voltage signal 250 is transformed into a second voltage signal 260 at a voltage transformer 220. The first voltage signal is provided from the EEC 210. The second voltage signal has a maximum amplitude equal to or above the igniter voltage threshold 240. At step 306, a fuel-air mixture is ignited in a combustor of the engine 10 by at least one igniter 230 with the second voltage signal 260. In some embodiments, at step 308, the first voltage signal is monitored by the EEC 210.

In some embodiments, the first voltage signal is monitored to assess an electromagnetic field produced by the voltage transformer 220 on the first voltage signal. In some embodiments, the first voltage signal is monitored to detect that the at least on igniter 230 has produced a spark. In some embodiments, the first voltage signal is monitored to detect that the engine 10 has started. In some embodiments, the first voltage signal is monitored to detect that the at least on igniter 230 has failed to produce a spark. In some embodiment, the EEC 210 may detect that the engine has failed to start when the at least one igniter 230 has failed to produce a spark. In some embodiments, the first voltage signal is monitored to detect that the engine 10 has failed to start. In some embodiments, the first voltage signal is monitored to obtain at least one characteristic of the first voltage signal when ignition by the at least one igniter 230 is expected to occur. The at least one characteristic may be used detect that a spark has occurred or has failed to occur. The at least one characteristic may be used detect that the engine 10 has started or has failed to start.

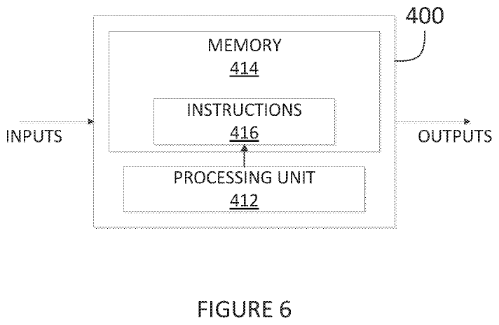

With reference to FIG. 6, the EEC 210 may be implemented using a computing device 400 comprising a processing unit 412 and a memory 414 which has stored therein computer-executable instructions 416. The processing unit 412 may comprise any suitable devices configured such that instructions 416, when executed by the computing device 400 or other programmable apparatus, may cause at least in part the functions/acts/steps of the method 300 as described herein to be executed. The processing unit 412 may comprise, for example, any type of general-purpose microprocessor or microcontroller, a DSP processor, a CPU, an integrated circuit, a FPGA, a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412. In some embodiments, the computing device 400 can be implemented as part of a full-authority digital engine controls (FADEC) or other similar device, including an engine control unit, and the like.

The methods and systems for starting an engine described herein may be implemented at least in part in a high level procedural or object oriented programming or scripting language, or a combination thereof, to communicate with or assist in the operation of a computer system, for example the computing device 400. Alternatively, the methods and systems for starting an engine may be implemented at least in part in assembly or machine language. The language may be a compiled or interpreted language. Program code for implementing at least in part the methods and systems for starting an engine may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for starting an engine may also be considered to be implemented at least in part by way of a non-transitory computer-readable storage medium having a computer program stored thereon. The computer program may comprise computer-readable instructions which cause a computer, or in some embodiments the processing unit 412 of the computing device 400, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for starting an engine may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

What is claimed is:

1. A system for starting a gas turbine engine, the system comprising:
an electronic engine controller configured to output a first voltage signal comprising at least one pulse when commanded to start the engine, the first voltage signal having a maximum amplitude below an igniter voltage threshold;
a voltage transformer coupled to the electronic engine controller and configured to transform the first voltage signal received from the electronic engine controller into a second voltage signal having a maximum amplitude equal to or above the igniter voltage threshold; and
at least one igniter coupled to the voltage transformer and configured to ignite a fuel-air mixture in a combustor of the engine with the second voltage signal received from the voltage transformer.

2. The system of claim 1, wherein the voltage transformer is an ignition coil.

3. The system of claim 1, wherein the at least one igniter is integrated with the voltage transformer.

4. The system of claim 1, further comprising at least one ignition lead coupling the voltage transformer to the at least one igniter.

5. The system of claim 1, wherein the electronic engine controller is further configured for monitoring the first voltage signal to assess an electromagnetic field produced by the voltage transformer on the first voltage signal.

6. The system of claim 1, wherein the electronic engine controller is further configured for monitoring the first voltage signal to detect that the at least one igniter has produced a spark.

7. The system of claim 1, wherein the electronic engine controller is further configured for monitoring the first voltage signal to detect that the at least one igniter has failed to produce a spark.

8. The system of claim 7, wherein the electronic engine controller is further configured for detecting that the engine has failed to start when the at least one igniter has failed to produce the spark.

9. The system of claim 1, wherein the electronic engine controller is further configured for monitoring the first voltage signal to obtain at least one characteristic of the first voltage signal when ignition by the at least one igniter is expected to occur.

10. The system of claim 1, wherein the electronic engine controller is further configured for detecting that the at least one igniter has produced a spark or has failed to produce the spark from the at least one characteristic.

11. A method for starting a gas turbine engine, the method comprising:
generating, at an electronic engine controller, a first voltage signal comprising at least one pulse, the first voltage signal having a maximum amplitude below an igniter voltage threshold;
transforming, at a voltage transformer, the first voltage signal into a second voltage signal; the second voltage signal having a maximum amplitude equal to or above the igniter voltage threshold; and
igniting, by at least one igniter, a fuel-air mixture in a combustor of the engine with the second voltage signal.

12. The method of claim 11, further comprising monitoring, at the electronic engine controller, the first voltage signal to assess an electromagnetic field produced by the voltage transformer on the first voltage signal.

13. The method of claim 11, further comprising monitoring, at the electronic engine controller, the first voltage signal to detect that the at least one igniter has produced a spark.

14. The method of claim 11; further comprising monitoring, at the electronic engine controller, the first voltage signal to obtain at least one characteristic of the first voltage signal when ignition by the at least one igniter is expected to occur.

15. The method of claim 14, further comprising detecting that the at least one igniter has produced a spark from the at least one characteristic.

16. The method of claim 11, wherein the voltage transformer is an ignition coil.

17. The method of claim 11, wherein the at least one igniter is integrated with the voltage transformer.

18. The method of claim 11, wherein the at least one igniter is coupled to the voltage transformer by at least one ignition lead.
